(19) United States
(12) Patent Application Publication
(10) Pub. No.: US 2026/0252053 A1
(43) Pub. Date: Aug. 27, 2026

(54) METHOD AND SYSTEM FOR MACHINING OF WORKPIECES

(71) Applicant: MAKINO MILLING MACHINE CO., LTD., Tokyo (JP)

(72) Inventors: Richard SCHARES, Aachen (DE); David WELLING, Aachen (DE); Marco BANGERT, Aachen (DE); Thorsten AUGSPURGER, Aachen (DE); Sebastian SPELZ, Aachen (DE); Marcel FEY, Aachen (DE)

(73) Assignee: MAKINO MILLING MACHINE CO., LTD., Tokyo (JP)

(21) Appl. No.: 19/159,183

(22) PCT Filed: Mar. 7, 2023
(86) PCT No.: PCT/JP2023/008663

§ 371 Date: Aug. 22, 2025

(51) Int. Cl. G05B 19/4097

(52) U.S. Cl. CPC G05B 19/4097; G05B 2219/35134; G05B 2219/40113

(57) ABSTRACT

There is provided a method of processing a workpiece, comprising the steps of: processing the workpiece by a pre-process; generating, after and/or during the pre-process, a virtual workpiece model as a representative of the workpiece; and planning for or adapting a post-process of the workpiece using the virtual workpiece model. We further describe a system configured to carry out the above method, comprising a data source, a data transmitter and a data processing system.

### TECHNICAL FIELD

The present invention generally relates to a method of processing a workpiece and a system configured to carry out a method of processing a workpiece, such that the workpiece is processed in an adaptive machining process in several stages.

### BACKGROUND ART

The machining of workpieces generally requires adaptive measures in order to take into account differences or deviations of the real semi-finished product geometry with the planned semi-finished product geometry, whereby the semi-finished product may also entail an initial product geometry. In particular, at multi-stage machining, which may be implemented, for example, in tool making or in volume production of cast/forged/printed components, such deviations of the real semi-finished product geometry from the planned semi-finished product geometry regularly occur. Since any subsequent process steps may generally be based on the real geometry of the semi-finished product, such deviations may result in negative effects.

While it may be possible to measure the semi-finished product stages with appropriate and accurate measuring equipment, such as, for example, a coordinate measuring machine (CMM), such measurements may need to take place outside the machine tool, the full machining surface may not be covered, and/or additional measurement time may be required. This may be inefficient and may slow down the entire machining process since teardown of at least a part may be required or it may in fact even be impossible over a free-form surface. Nowadays, a safety offset may be chosen and corrective cuts may be made, which results in an inefficient process of manufacturing a workpiece.

In some examples, advanced a-priori simulations, which may consider many relevant aspects of the process and the machine, may be used in order to avoid reworking any steps. However, such a-priori simulations may not be applicable for cases for which the initial workpiece geometry is not known. Therefore, an additional all-over measurement of at least a part may again be necessary in order to be able to provide for corrective measures when deviations of the real semi-finished product geometry from the planned semi-finished product geometry are detected.

In CN 102865847 A, numerical control machining is applied by using a spline curve compensation method for measuring a profile deviation based on a path unit. In DE 602 22 026 T2, a Standard for the Exchange of Product model-Numerical Controller (STEP-NC) is used in order to overcome shortcomings of conventional NCs with a closed structure.

Further prior art can be found, for example, in DE 11 2015 004 939 B4 , which generally relates to a method for optimising the productivity of a machine process of a CNC machine, and in WO 2016/065492A1, which generally relates to a computer-implemented method for part analytics of a workpiece machined by at least one CNC machine.

In view of the above, there is a need for improving machining of workpieces.

### SUMMARY OF INVENTION

The invention is set out in the independent claims. Preferred embodiments of the invention are outlined in the dependent claims.

According to an aspect of the present disclosure, there is provided a method of processing a workpiece, comprising the steps of: processing the workpiece by a pre-process; generating a virtual workpiece model as a representative/representation of the (real) workpiece; and planning a post-process of the workpiece using the virtual workpiece model. In some examples, the virtual workpiece is generated during machining, for example with a latency of, for example, 5 ms or 10 ms after the pre-process is completed, and/or it may be generated one or more seconds and/or one or more minutes and/or one or more hours and/or one or more days (or longer) after the pre-process has been completed.

By using a virtual workpiece model, which may be generated from internal machine data (which may be control data for controlling the machine tool and/or process data, such as, but not limited to force and/or vibration and/or temperature data, as will be outlined further below), at process planning of one or more post-processing steps, the machining process may be shortened and quality of the produced workpiece may be enhanced. The workpiece model may carry the imperfection of the real world and may allow for a better-founded path planning/or it may allow for a better linking of a plurality of (e.g. two) machining steps.

The virtual workpiece model may, in some or any one of the examples outlined throughout the present disclosure, be unique to the processing of a particular workpiece, in particular as the virtual workpiece model may be generated from internal machine data.

The virtual workpiece model may, in some examples, relate to the geometry of the workpiece. Additionally or alternatively, the virtual workpiece model may refer to one or more other parameters of the workpiece and/or the process for producing the workpiece, whereby the one or more other parameters may be location-resolved and/or time-resolved. The one or more parameters may, in some examples, be or relate to a force (for example a force encountered by the machine tool during the machining process at cutter tool engagement), an acceleration (for example of the machine tool at a tool center point), a temperature (for example of a machine tool component and/or of the workpiece during the machining process), a vibration (for example of a machine tool component and/or of the workpiece during the machining process), and other parameters related to the machining process, such as, for example, a bending of the processed workpiece and/or a mathematical calculation for the drilling/cutting of the machine tool through the processed workpiece.

In view of the above, in some examples, the virtual workpiece may be defined as a geometry describing a virtual representation of the workpiece shape in a workpiece coordinate system (including, in some examples, a surface description of different orders and/or one or more geometrical errors of a surface of higher order) at any time of the manufacturing process. In some examples, the definition of the virtual workpiece may alternatively or additionally include a wider definition as to comprising one or more of meta data, (any) sensor data, one or more process parameters and measured sensor data at a part surface at any time of the manufacturing process.

The virtual workpiece may be based on a trace used in the machining process, whereby the trace may be or comprise a list with several numerical control (NC) and/or programmable logic controller (PLC) and/or sensor data (topics) in the time domain with a synchronized timestamp.

In any one or more (or all) of the examples outlined throughout the present disclosure, the post-process may be defined as a second (for example intermediate and/or final) process taking place after the pre-process, and, accordingly, the pre-process may be defined as a first (for example initial) process taking place before the post-process. Therefore, generally, the pre-process may be a first process, the post-process(ing) may be a second process, and the first process takes place before the second process.

In some examples of the method, the pre-process and/or post-processing are conducted using one or more numerical control (NC) code blocks.

In some examples of the method, at least one of the pre-process and post-processing is planned via computer-based path planning. The computer-based path planning may hereby, in some examples, relate to a path planning of the machine tool. The path planning may be taken into account in the process planning for the post-process. Path planning may take place for one or both of the pre-process and the post-process. The path planning may, in some examples, be performed via a computer aided manufacturing (CAM) algorithm.

In some examples of the method, at least one machine tool, a number of which is equal to or less than a number of process steps used to process the workpiece using the pre-process and the post-processing, is used to perform the pre-process and the post-process.

In some examples of the method, (real) data from a controller of the machine tool and/or from an integrated sensor in the machine tool are used to generate the virtual workpiece model. The (real) data may, in some examples, relate to the internal machine data outlined throughout the present disclosure.

In some examples of the method, the virtual workpiece model is generated quasi-parallel to the pre-process and/or after the pre-process. In some examples, quasi-parallel means with a latency of less than 50 ms, preferably less than 10 ms. This may allow for efficient production of the workpiece.

In some examples of the method, the virtual workpiece model is generated by considering one or more displacements of one or more physical components (of the workpiece) which are caused by a force loop. In some examples, the physical component may be the cutting tool and/or the clamping/fastening device. Additionally or alternatively, in some examples, the stiffness of one or more machines and/or parts, and/or one or more corrective tables may be taken into account when determining the one or more displacements. Additionally or alternatively, the workpiece itself may deform by the process force and/or clamping force.

In some examples of the method, the virtual workpiece model is generated by considering a (virtual workpiece model) compensation algorithm running on a machine or a NC controller. In some examples, a compensation algorithm may relate to a geometry error of the kinematics and/or thermal compensation, which may be taken into account during generation of the virtual workpiece.

In some examples of the method, the generation of the virtual workpiece model is conducted with a local geometrical resolution smaller than the part-specific local geometric dimensioning and tolerancing (GDT). The resolution may hereby be smaller than features which may be measured subsequently on the virtual workpiece model.

In some examples of the method, after the pre-process, a micro- or sub-micrometer accurate measurement, in particular conducted by a coordinate measuring machine and/or using in-machine tactile probing and/or an optical measurement, and a measured point cloud are used to enrich and/or correct one or more (specific) areas of the virtual workpiece model. For calibration purposes, a complete model of the surface of the virtual workpiece model may be obtained.

In some examples of the method, calibration of a process model as a function of one or more boundary conditions is conducted in parallel to the pre-process. The process model may comprise one or more of a force model, a tool material (model) and a workpiece model. The tool-material-model may hereby relate to a cutting tool (e.g. geometry, material)-workpiece material-model. The tool material-model (cutting tool-workpiece material-model) may be a model based on one or more parameters for solving a force calculation equation (for example Kienzle formula), which depends on one or more parameters which may depend, for example, on one or more of the cutter geometry, tool wear, lubrication, tool material and workpiece material (in particular relating to a local property and/or a global property over the entire workpiece of the workpiece). The force calculation equation may additionally or alternatively be influenced by one or both of a heat condition and a de-solidification condition around each cutting edge and/or defined by certain spindle speed, cutter-workpiece engagement or feed speed. Additionally or alternatively, the one or more parameters may be or relate to stiffness and/or deformability of the tool and/or the workpiece, respectively.

In some examples, calibration of a process model may comprise an initial generation of the process model and/or a subsequent adaptation of the process model. In some examples, an initial model (e.g. a Kienzle model) may subsequently be calibrated/adapted.

Throughout the present disclosure, the tool-material-model may be a cutting tool (e.g. geometry and/or material, etc.)-workpiece material-model.

The model may, in some examples, be an empirical model.

Based on the tool material-model (cutting tool-workpiece material-model), cuts may be calculated, whereby a physical simulation (cutter-workpiece engagement calculation driven by trace data) may be used to determine how much cutting force is generated when machining the workpiece with the machine tool or an spindle-integrated force sensor or an force measurement platform at table. Within the physical simulation, the cutting condition(s) (e.g. ae (radial depth of cut), ap (axial depth of cut), volume) and/or force direction and/or force value are calculated. The engagement simulation is based, e.g., on bool, dexel or voxel operations.

One or more tool material-models (cutting tool-workpiece material-models) may be stored in a database and may be available for one or more next process steps and/or for subsequent parts to be manufactured.

In some examples, the calibrated process model (tool material-workpiece material-model) is used for planning the post-processing.

In some examples of the method, calibration of a tool-material-model (tool material-workpiece material-model) is conducted in parallel to the post-processing. This may allow for post-calibration of the model.

In some examples of the method, the planning of the post-processing is conducted using an initial workpiece geometry which is based on the virtual workpiece model. In some examples, the virtual workpiece model may be used as the initial geometry without any further workpiece geometry information to define the initial workpiece geometry. The data for the post-process planning may, in some examples, be sent from (or obtained via) the machine tool conducting the pre-process. In some examples, the planning of the post-processing is conducted after the pre-process and the generating of the virtual workpiece model.

In some examples of the method, one or more process parameters (such as feed rate and rotational speed, and e.g. not just a path) are adjusted based on higher order shape deviations on the virtual workpiece model at the planning of the post-process. Such higher order shape deviations may relate, for example, to one or more of waviness, roughness and other surface features of higher order.

In some examples of the method, one or more supplementary sensor signals, in particular acceleration data, are added to the virtual workpiece model in a location-related (geometric) manner. Additionally or alternatively, one or more signals from a controller of the machine tool and/or from one or more external sensors (which may, in some examples, not be critical to the machining process) may be added to the virtual workpiece model. The supplementary information may be used in order to adjust one or more process parameters, such as, but not limited to the feed rate and/or rotational speed (of the machine tool).

In some examples of the method, the planning of the post-process is conducted by a simulation of an ideal geometry obtained in the planning of the pre-process as an initial workpiece geometry. The planning may hereby, in some examples, be a CAM planning in a first step based on an ideal final geometry of the workpiece. In some examples, the method further comprises a step of planning paths for the post-process. Path planning for the post-process may take place before and/or during and/or after the pre-process.

In some examples of the method, one or more initially calculated paths for the post-process are adjusted based on an additional input generated from the virtual workpiece model. The additional input may, in some examples, be a deviation, and one or more other parameters (e.g. surface roughness and/or one or more parameters of higher order) may be used additionally or alternatively to a deviation. Additionally or alternatively, in some examples, this adjustment may be based on a (internet) cloud-service.

In some examples of the method, one or more variables for a parametrized NC (numerical control) code and/or a pose-dependent offset table depending on geometry deviation and/or displacement of a tool center point are generated using the virtual workpiece model. The offset table may additionally or alternatively be location-dependent. The offset table throughout the present disclosure may provide offset information in one or more dimensions, in particular for 3-axis or 5-axis machining. As a further example of the method, the initially created NC code for the post-process is modified within a path adaptation engine using the virtual workpiece model. Interpretation of the initial NC code considering dialect of a specific machine tool, called NC parser, of the post-process before path modification as well as post processing after modification may be included.

One or more offset tables may (for example together with the one or more tool material-models (cutting tool-workpiece material-models) be stored in the database and may be available for subsequent parts to be manufactured.

The adaption of a machine path may not be limited to the method of an offset table-further methods for micrometer-based correction of machining paths are possible.

In some examples of the method, the path adjustment is conducted by a controller of a machine tool (used to process the workpiece) so that one or more final paths are generated in a NC device and/or in the machine tool. This adjustment may be done (quasi) in parallel to the machining process. The final path may be generated in the NC or on the machine, either by actual data adjustment or by target data adjustment.

In some examples of the method, one or more target paths for the post-process are adjusted on-premise and/or in a (internet) cloud. In some examples, no update in the NC may be provided.

In some examples of the method, the path adjustment is less than a predefined threshold, wherein the predefined threshold is based on one or more process parameters for processing (during the pre-process and/or the post-processing) the workpiece and/or based on a tool geometry of a tool used to process (during the pre-process and/or the post-processing) the workpiece. In some examples of the method, the path adjustment is a displacement of a single path which is smaller than the overlap of adjacent cutting contours. In some examples, additional (e.g. all) paths may be added.

In some examples of the method, the predefined threshold is less than half of a tool diameter of the tool. This allows for even smaller division when adjusting the one or more paths. Generally, the predefined threshold may be defined based on a kinematic roughness expected to be present and/or measured when processing the workpiece.

In some examples of the method, the one or more paths are adjusted by adding a single path segment.

In some examples of the method, the planning of the post-processing includes a determination of a virtual tool (cutter)-workpiece engagement (as preparation for example for a force determination) and a calculation of a displacement of a tool center point. A measured virtual path may hereby be used. The simulation may take place, in some examples, with a conventionally (also initially) calculated and/or an adapted path. This simulation may, in some examples, be a virtual (for example iterative) process optimization before the post-processing step.

In some examples of the method, a tool-material-model (tool material-workpiece material model) which is set-up and/or calibrated in the pre-process is used for the planning.

In some examples of the method, a virtual NC controller, in particular including one or more offset tables, in particular NC-internal correction/compensation, is used to calculate an expected real path relevant for an a-priori simulation of the virtual workpiece model. This may allow for interpreting the one or more offset tables and help better predicting the result in general, in particular by including NC-internal correction/compensation.

In some examples of the method, a target path (for the tool) is generated (in particular virtually) iteratively in consideration of the displacement of a/the tool center point. As this requires fewer real steps in the method, costs are further reduced when preparing the workpiece.

In any one of the examples outlined herein, the adaptation is not limited to an open loop control of the path. Based on a fast and real time data measurement, cutter-workpiece engagement calculation, force calculation, tool center point (TCP) deflection calculation, compensation definition, a-priori TCP deflection simulation and path adaptation at NC, also a closed loop control of the path as well as process parameters is possible. In some examples of the method, the above steps happen in parallel or after a processing sequence (fraction of a process or roughing/finishing) or happen constantly in each fraction of a single path.

In some examples of the method, the post-process is conducted by an electric discharge machine. Spark-erosive machining including specific process planning may hereby be planned for the post-process. In some examples, knowledge about a real electrode geometry for the electric discharge machine as a virtual workpiece model may help optimizing the precise result obtained via the electric discharge machine.

In some examples of the method, the post-process is conducted by an electrochemical machining. In some examples, knowledge about a real cathode geometry for the electrochemical machine as a virtual workpiece model may help optimizing the precise result obtained via the electrochemical machine.

In some examples, the method further comprises a step of a micro-/sub-micrometer accurate part measurement process after the pre-process, and a corresponding measurement point cloud is used to correct a coordinate system of the virtual workpiece model relative to a reference point, in particular relative to an electrode (EDM) and/or a cathode (ECM) zero-point clamping.

According to another aspect of the present disclosure, there is provided a system configured to carry out the method according to any one or more of the examples outlined throughout the present disclosure. The system comprises a data source, a data transmitter and a data processing system.

In some examples of the system, the data source is a machine tool with a data interface for sending and/or reading machine internal data with high (that is above a threshold) sampling rate.

In some examples of the system, the data is provided by the data interface at a frequency of less than 2 kHz for providing PLC data, and/or between 100 Hz and 20 kHz for providing servo data, and/or between 2 kHz and 40 kHz for providing a rotor shaft deformation.

In some examples of the system, the data includes one or more of: electric current supplied to a motor, signals from a rotary encoder and/or linear scale, a displacement of a spindle shaft, one or more tool tables, one or more compensation tables, and one or more NC blocks. This data may be read out from the machine.

In some examples of the system, the data is obtained from a sensor for measuring a rotor shaft deformation in front of and/or between a pair of bearings. Additionally or alternatively, the data may relate to one or more lathes and/or a turning process.

In some examples of the system, the data source is a machine-internal job manager and/or a (e.g. higher-level) cell controller and/or a manufacturing execution system.

In some examples, the system is configured to provide job information and/or context information from one or more pre-processes and/or corresponding one or more images of the workpiece.

In some examples of the system, the data source, the data transmitter and the data processing system for the generation of the virtual workpiece model which comprise a software unit for material removal simulation and a software unit for determining deformations, are provided with a software unit for computer-aided path planning (e.g. CAM), in particular a machine tool including an edge PC housed therein. The system may thus be provided within or on (i.e. coupled with) the machine tool. This may be particularly advantageous since integration of the system on the machine may allow for real-time application of the example implementations of the method outlined throughout the present disclosure. Calculation and implementation of the system at the machine further allows for realizing a self-sustaining/autarkic system.

### BRIEF DESCRIPTION OF DRAWINGS

These and other aspects of the invention will now be further described, by way of example only, with reference to the accompanying figures, wherein like reference numerals refer to like parts, and in which:

FIG. 1 shows a schematic illustration of steps of a sequence according to some example implementations of the present disclosure;

FIG. 2 shows a schematic illustration of steps of a sequence according to some example implementations of the present disclosure;

FIG. 3 shows a schematic illustration of steps of a sequence according to some example implementations of the present disclosure;

FIG. 4 shows a schematic illustration of steps of a sequence according to some example implementations of the present disclosure;

FIGS. 5a to 5c show cross-sectional side views of schematic illustrations of cuts made when processing a workpiece;

FIG. 6 shows a schematic illustration of steps of a sequence according to some example implementations of the present disclosure;

FIG. 7 shows a schematic illustration of steps of a sequence according to some example implementations of the present disclosure;

FIG. 8 shows a schematic illustration of steps of a sequence according to some example implementations of the present disclosure;

FIG. 9 shows a schematic illustration of steps of a sequence according to some example implementations of the present disclosure;

FIG. 10 shows a schematic illustration for refinement of a virtual workpiece model coordinate system according to some example implementations of the present disclosure;

FIG. 11 shows a schematic illustration of a system set-up according to some example implementations of the present disclosure;

FIG. 12 shows a flow diagram of a method according to some example implementations of the present disclosure; and

FIG. 13 shows a schematic block diagram of a system according to some example implementations of the present disclosure.

### DESCRIPTION OF EMBODIMENTS

According to example implementations outlined throughout the present disclosure, the machining steps may be adapted faster to the planned geometry by using a virtual workpiece model which is generated from internal machine data of a pre-processing step.

The internal machine data may hereby relate, for example, to the position(s) that the machine tool goes through and/or forces which may act on one or more motors of the machine tool. Generally, the internal machine data may refer to data for controlling the machine tool. In some examples, no data obtained by subsequent measurements may hereby be taken into account for the internal machine data.

The internal machine data may relate to data stemming from the current machining process. In some examples, the internal machine data may relate to one or more of a force, an acceleration, a temperature, a vibration, and other parameters related to the machining process, such as, for example, a bending of the workpiece (for example with a resolution of less than 50 μm) to be produced and/or bending of the machine (cutting) tool, and/or a mathematical calculation for the drilling/cutting of the machine tool through the workpiece to be produced. The data may be obtained during the (current) machining process. The data may stem from a controller for controlling the machine tool and/or a sensor which may not (at least not directly) be connected to the controller.

The internal machine data may, in some examples, be mapped to a positional resolution of 1 micrometer or less (e.g. 1 picometer). Additionally or alternatively, the internal machine data may be time-resolved.

Given that, for example, safety cuts or additional correction cuts including measurements using a CMM may be eliminated according to examples outlined throughout the present disclosure, the costs for producing the workpiece may be reduced potentially significantly. Furthermore, quality improvements of the workpiece to be produced may be achieved. Knowledge of the real geometry after an initial machining step in the event of fluctuating and/or unknown blank geometries, for example in the case of castings or additive manufacturing, may be obtained. Furthermore, better knowledge of the real geometry of the semi-finished product stages may be gained, thereby saving/eliminating safety cuts and achieving higher tolerance accuracy after post-processing (for example for DM).

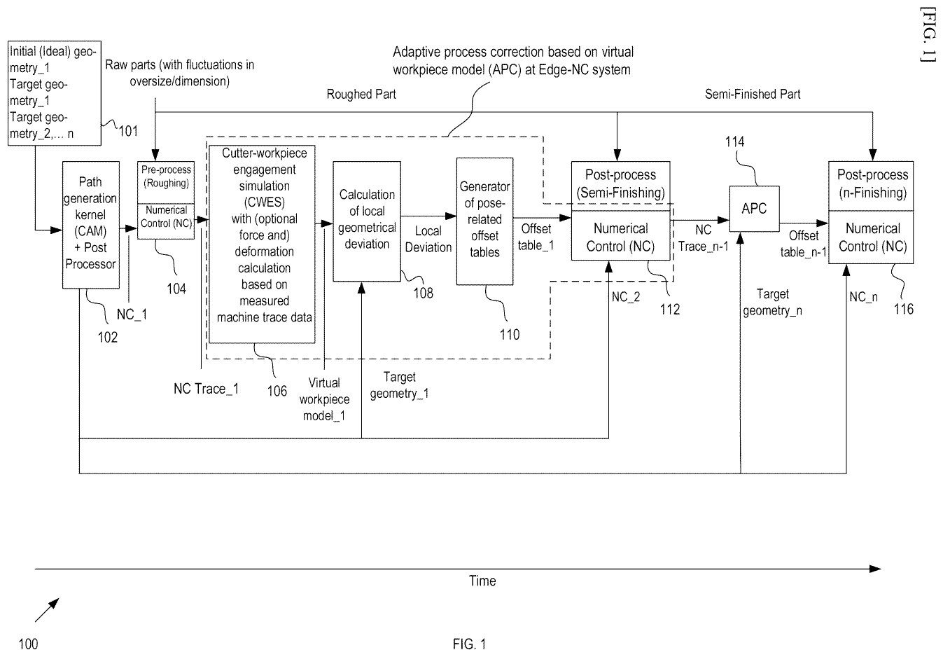

FIG. 1 shows a schematic illustration of steps of a sequence 100 according to some example implementations of the present disclosure.

In some examples, the sequence 100 may be used for machining of casted, forged or additive manufactured parts in series.

In the sequence 100, one or more pose-related offset tables may be generated as an input into the numerical control of a step (that is any one or more or all steps) for processing the workpiece.

In this example, an initial (ideal) geometry is provided at step 101 to a path generation kernel (computer aided manufacturing (CAM)) and a post processor, whereby the initial geometry_2, . . . , n corresponds to the target geometry_2-1, . . . , n−1.

In this example, the path generation kernel (computer aided manufacturing (CAM)) and the post processor are used at step 102 in order to output data/program NC_1 (“numerical control_1”) used in order to control the machine tool used to manufacture a workpiece.

The post processor may hereby, in some examples, process the path planning result after its generation. It may contain (1) adding one or more process parameters and/or spindle stop/run etc. to the path data (CAM may calculate only the path in a 3D environment), (2) describing the path as a vector-list (e.g. movement commands), (3) generating the NC code in a machine tool specific dialect (e.g. M and G codes vary for specific machine tools/machine tool vendors/NC vendors).

The data NC_1 is provided, in this example, to a pre-process 104, which may be a roughing process when preparing a workpiece. In the pre-process, in this example, (computer) numerical control (NC) machining is used in the manufacturing progress in which pre-programmed computer software may be used to control movement of the machine tool.

In this example, in the pre-process 104, raw parts (with (potential) fluctuations in oversize and/or dimension) are processed in the pre-process.

The NC used in the pre-process outputs, in this example, data NC Trace_1, which may be or comprise a list with several numerical control (NC) and/or programmable logic controller (PLC) and/or sensor data (topics) in the time domain with a synchronized timestamp.

With the roughed part having been prepared, and adaptive process correction based on the virtual workpiece model (APC) at an Edge-NC system is performed. In the APC process, a machine tool (cutter)-workpiece engagement simulation (CWES) with deformation calculation (and optional force calculation) is performed at step 106 in this example based on measured machine trace data (in this example based on NC Trace_1). A virtual workpiece model (virtual workpiece model_1) generated from step 106 is provided for a calculation of a local geometrical deviation at step 108. Data regarding the target geometry (target geometry_1) is, in this example, hereby provided from the path generation kernel (computer aided manufacturing (CAM)) and post processor into the calculation of the local geometrical deviation at step 108.

The local deviation calculated at step 108 is then, in this example, provided to a generator of pose-related offset tables 110, where one or more offset tables are generated and provided to a numerical control (NC) used in a post-process (in this example a semi-finishing process) is performed at step 112 using the one or more offset tables. In this example, numerical control data NC_2 is provided from the path generation kernel (computer aided manufacturing (CAM)) and post processor to the NC for the post-process (semi-finishing).

In this example, data NC Trace_n−1 is output by the NC of the post-process (semi-finishing) to a further adaptive process correction (APC) 114, which may implement steps corresponding to those outlined at steps 106 to 112. In this example, data relating to the target geometry of the workpiece for the n-th processing step (target geometry_n) provided from the path generation kernel (computer aided manufacturing (CAM)) and post processor is input in the APC 114.

From the APC 114, an offset table_n−1 is provided to numerical control (NC) where a post-process (in this example an n-th step that is a finishing process) is performed at step 116, in order to obtain from the semi-finished part the final processed workpiece. In this example, data NC_n is provided from the path generation kernel (computer aided manufacturing (CAM)) and post processor to the NC for the post-process performed at step 116.

As can be seen, the generator of pose-related offset tables is used in the manufacturing sequence in order to generate an adaptation based on a virtual geometry of the workpiece and a location deviation. The offset table(s) may be used as an input in the execution of the manufacturing of the workpiece based on a previous (ideal) planning.

In this example, all steps of the manufacturing process of the workpiece are planned from the outset based on an ideal geometry. In this example, n CAM steps are performed together at the planning of the manufacturing process of the workpiece.

The sequence shown in FIG. 1 may in particular be applied to cast parts, which may relate to (relatively cheap) components/parts which may be manufactured relatively quickly/with a higher frequency compared to other sequences outlined throughout the present disclosure.

The one or more offset tables generated by generator of pose-related offset tables are based on a difference between an ideal workpiece and the virtual workpiece. Parameters of the ideal/virtual workpiece which may be taken into account in this comparison relate to one or more of a geometry of the workpiece, a temperature of the workpiece, a vibration of the workpiece, a bending of the workpiece, and others. In some examples, the offset provided in the offset tables may be location-resolved and/or time-resolved.

It is hereby to be noted that throughout the present disclosure, whenever reference is made to a plurality of offset tables, a single offset table may be used/generated in the described example implementations instead of a plurality of offset tables.

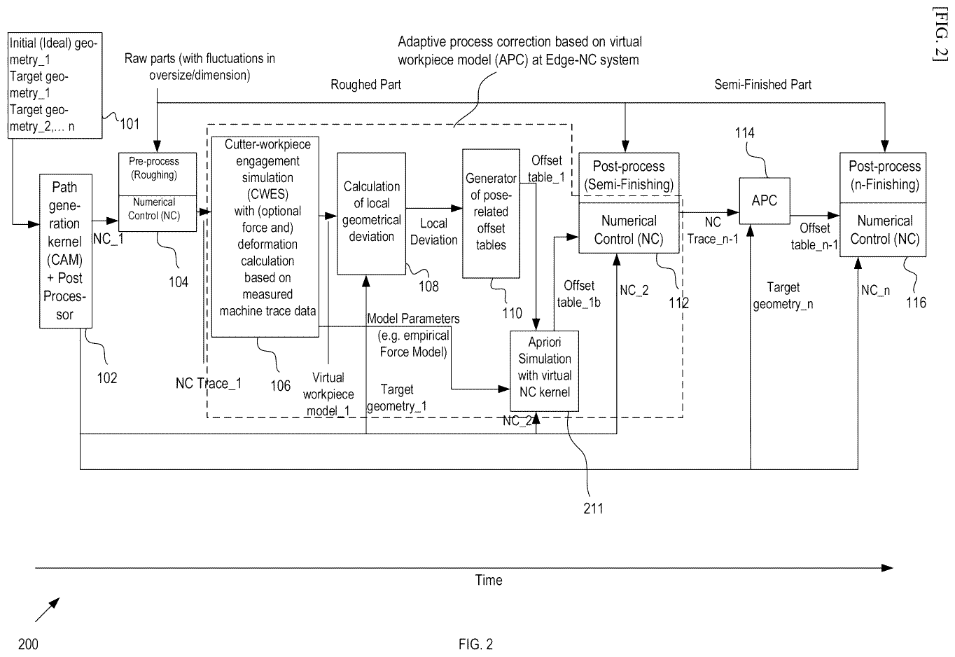

FIG. 2 shows a schematic illustration of steps of a sequence 200 according to some example implementations of the present disclosure.

The sequence 200 generally corresponds to the sequence 100 as shown in FIG. 1. However, in sequence 200, an a-priori simulation with a virtual NC kernel is performed at step 211. For the a-priori simulation, one or more model parameters (for example an empirical force model) is input from the machine-tool (cutter)-workpiece engagement simulation. Furthermore, in this example, the generator of pose-related offset tables is configured to output offset table_1 used as an input in the a-priori simulation. Furthermore, in this example, data NC_2 is provided from the path generation kernel and post processor as an input for the a-priori simulation. With the a-priori simulation, offset table_1b is generated and provided as an input to the numerical control in the post-process (semi-finishing) at step 112.

As can be seen, the a-priori simulation is part of the adaptive process correction based on the virtual workpiece model. With the a-priori simulation, the difference between the nominal contour of the workpiece and the manufactured contour of the workpiece after processing the workpiece can be reduced compared to the process implemented in the sequence of FIG. 1.

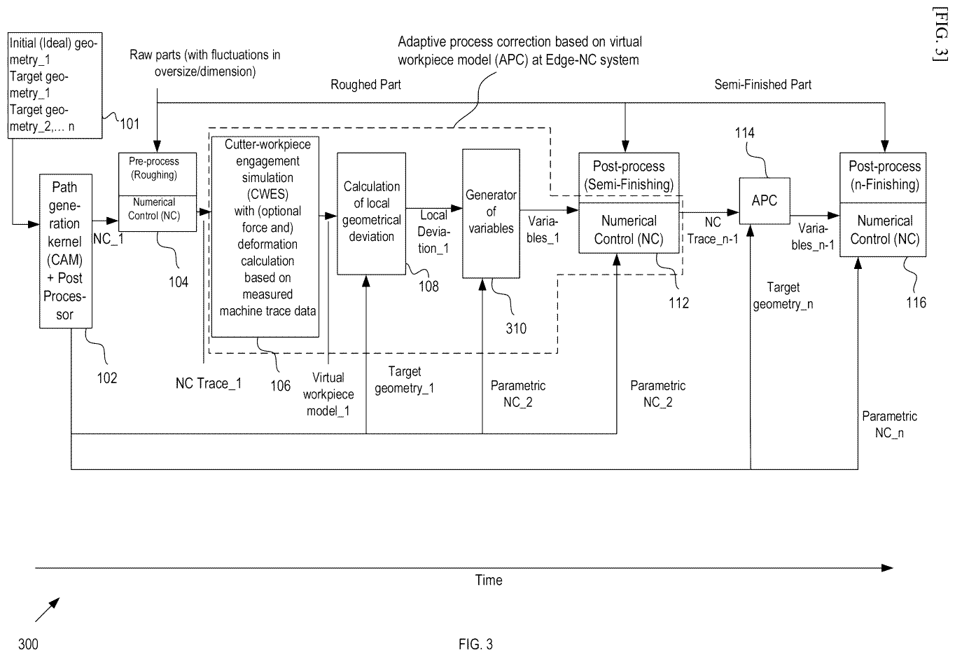

FIG. 3 shows a schematic illustration of steps of a sequence 300 according to some example implementations of the present disclosure. In sequence 300, one or more variables are generated for a parametric NC code used at different steps for processing the workpiece.

The sequence 300 generally corresponds to the sequence 100 as shown in FIG. 1. However, in sequence 300, instead of a generator of pose-related offset tables, a generator of variables is used at step 310 to generate, from the local deviation obtained when calculating the local geometrical deviation (that is the deviation between the virtual workpiece model and the ideal geometry), one or more variables 1 which are input to the numerical control for the post-process (semi-finishing). When generating the variables, parametric NC_2 data is input to the generator of variables. Furthermore, data parametric NC_2 is also input to the numerical control for the post-process (semi-finishing). The data parametric NC_2 may include, for example, one or more variables which allow for path modification for specific features of the workpiece. The data is, in this example, input to the generator of variables 310 so that the generator of variables 310 knows which parameter or parameters are to be optimized, and in which manner (i.e. based on modifying the path based on which parameters) the target geometry is to be reached via the post-process. In some examples, the one or more parameters may be found in a fit algorithm.

The above is equally applicable in the APC 114, from which variables_n−1 are generated and input (together with data parametric NC_n) to numerical control for the post-process (n-th step of finishing the workpiece).

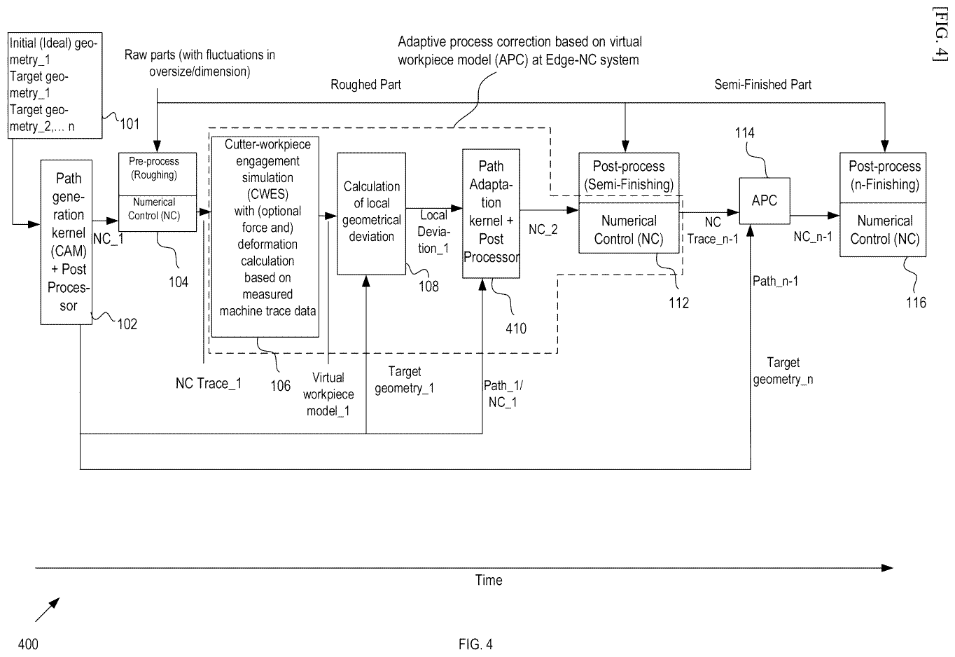

FIG. 4 shows a schematic illustration of steps of a sequence 400 according to some example implementations of the present disclosure.

Sequence 400 generally corresponds to sequence 100, 200 or 300. However, instead of a generator for pose-related offset tables/variables used in sequence 300, in sequence 400, path adaptation kernel and post processeor are used at step 410 for generating an NC code as an input to the numerical control of a post-process (in this example the semi-finishing and, respectively, the n-th process step for finishing the workpiece). It may be possible to input only the path_1 or the NC_1. In case of NC_1, a NC parser may, in some examples, need to be integrated.

In any one or more of the example implementations outlined throughout the present disclosure, on an edge of the workpiece, no new movements may be calculated, but merely corrections/adaptations may be provided in the machining process.

Furthermore, it is possible to apply the offset table/variable calculated for a previous part in the batch already at the pre-process to minimize oversize from first operation.

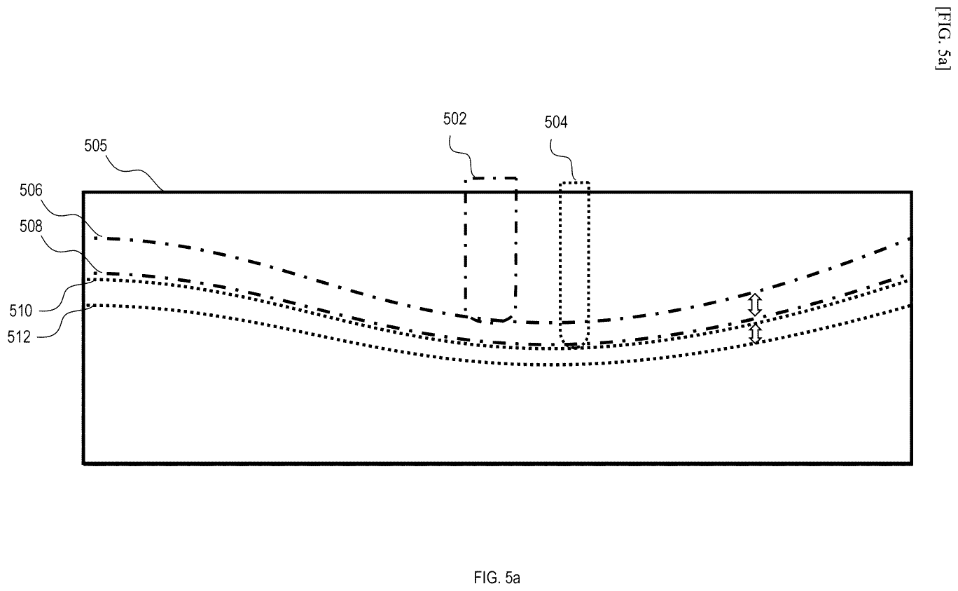

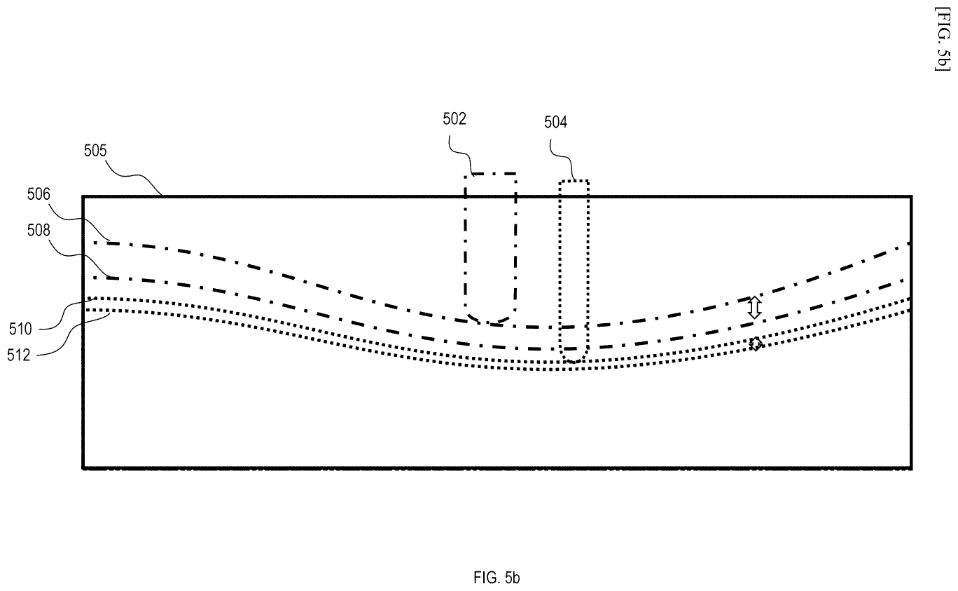

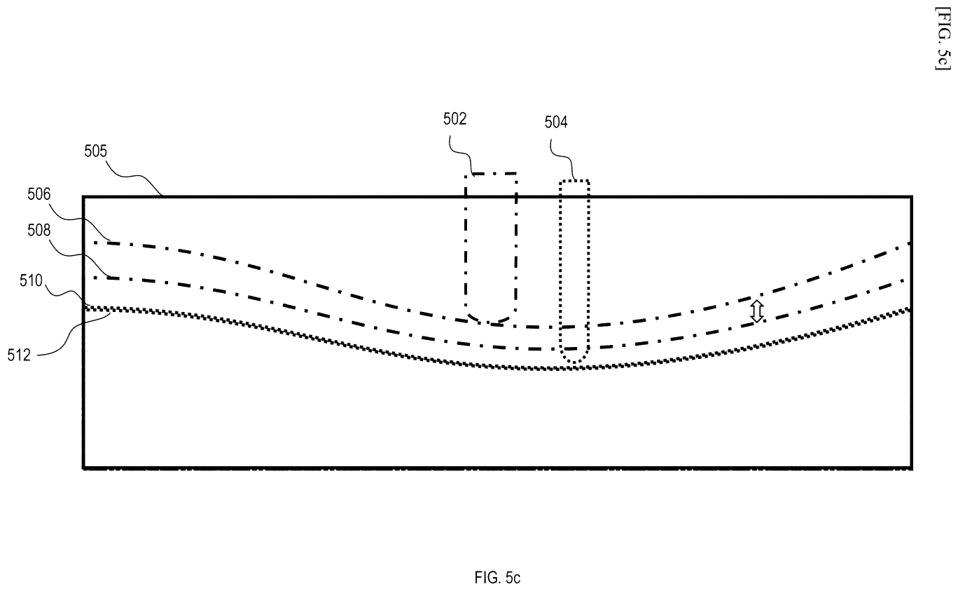

FIG. 5 a to c show cross-sectional side views of schematic illustrations of cuts made when processing a workpiece.

In FIG. 5a to c, a schematic illustration of a cutting tool 502 and a schematic illustration of a cutting tool 504 are shown, which may be used in order to process/cut the workpiece. Cutting tool 502 may hereby be used for a roughing process, and/or cutting tool 504 may be used for a semi-finishing process and/or finishing process. As will be appreciated, a single cutting tool may be used in the examples of FIG. 5a to c for the different cutting processes.

In FIG. 5a, no consideration of an intermediate part geometry after the roughing process (virtual workpiece model) is used when performing the post-process.

In this example, a raw part 505 of the workpiece is first cut via cutting tool 502. As can be seen, the manufactured contour after roughing 506 deviates from the nominal contour after roughing 508, resulting in a local error in the pre-process (indicated via the upper arrow in FIG. 5a).

After the roughing process, the workpiece is cut via cutting tool 504. As can be seen, the manufactured contour after finishing 510 deviates from the nominal contour after finishing 512 (which is the target part geometry), resulting in a local error in the post-process (indicated via the lower arrow in FIG. 5a).

In FIG. 5b, an intermediate part geometry is considered after the roughing process (virtual workpiece model) when performing the post-process.

In this example, a raw part 505 of the workpiece is first cut via cutting tool 502. As can be seen, the manufactured contour after roughing 506 deviates from the nominal contour after roughing 508, resulting in a local error in the pre-process (indicated via the upper arrow in FIG. 5b).

After the roughing process, the workpiece is cut via cutting tool 504. As can be seen, the manufactured contour after finishing 510 deviates from the nominal contour after finishing 512 (which is the target part geometry), resulting in a local error in the post-process (indicated via the lower arrow in FIG. 5b). However, the local error in the post-process is smaller in the process shown in FIG. 5b compared to the process shown in FIG. 5a.

In FIG. 5c, an intermediate part geometry is considered after the roughing process (virtual workpiece model) when performing the post-process, whereby an a-priori simulation is used when planning the post-process.

In this example, a raw part 505 of the workpiece is first cut via cutting tool 502. As can be seen, the manufactured contour after roughing 506 deviates from the nominal contour after roughing 508, resulting in a local error in the pre-process (indicated via the upper arrow in FIG. 5c).

After the roughing process, the workpiece is cut via cutting tool 504. As can be seen, the manufactured contour after finishing 510 does not (or hardly) deviate from the nominal contour after finishing 512 (which is the target part geometry), resulting in no (or minimal) local error in the post-process. Therefore, the local error in the post-process shown in FIG. 5b (and in FIG. 5a) can be avoided in the process shown in FIG. 5c.

In some examples, with a first cut, a raw part of the workpiece is processed. Based on a path originally calculated to realize a nominal (ideal) geometry, a certain contour (“is contour”) is obtained. This certain contour is different due to physical effects not considered during original path planning. While an unknown oversize is initially present in the processed workpiece, a tool center point displacement is determined subsequently based on machine internal (real) data, called virtual workpiece model with a predicted obtained contour. This allows the determination of deviation between nominal contour and the predicted obtained contour, such that the oversize may be determined.

In other words, this deviation may be added to the machine tool (cutter)-workpiece engagement in the post-process. In a second cut, the oversize is known, which allows for calculating a tool center point displacement for compensation such that the “is contour” aligns with the finished part. In some examples, a single iteration when applying the oversize information in the planning/performing of the second cut may be provided. However, any residual oversize may still be present after a second cut.

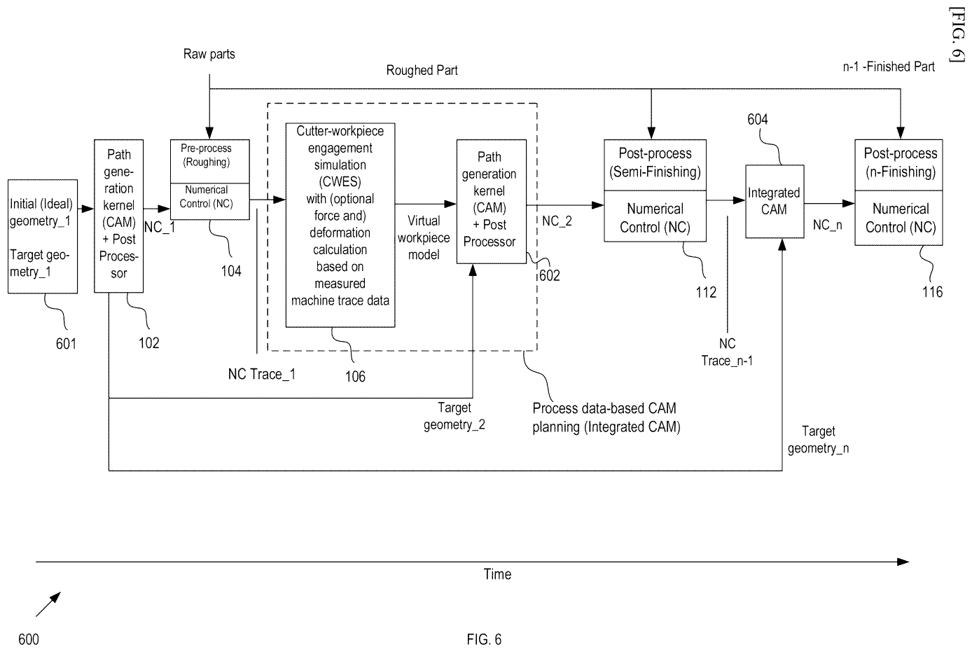

FIG. 6 shows a schematic illustration of steps of a sequence 600 according to some example implementations of the present disclosure. Generally, process data (in particular the virtual workpiece geometry) from a previous manufacturing step is used in CAM planning for the actual manufacturing step.

In this example, Initial (Ideal) geometry_1 and Target geometry_1 are input at step 601 to the path generation kernel (CAM) and post processor.

A virtual workpiece model obtained via a machine tool (cutter)-workpiece engagement simulation 106 is provided to a second path generation kernel (CAM) and post processor 602. The cutter-workpiece engagement simulation together with the path generation kernel (CAM) and post processor 602 are used for process data-based CAM planning (Integrated CAM), which may be implemented n times until and including the (n-th) finishing (post-)process.

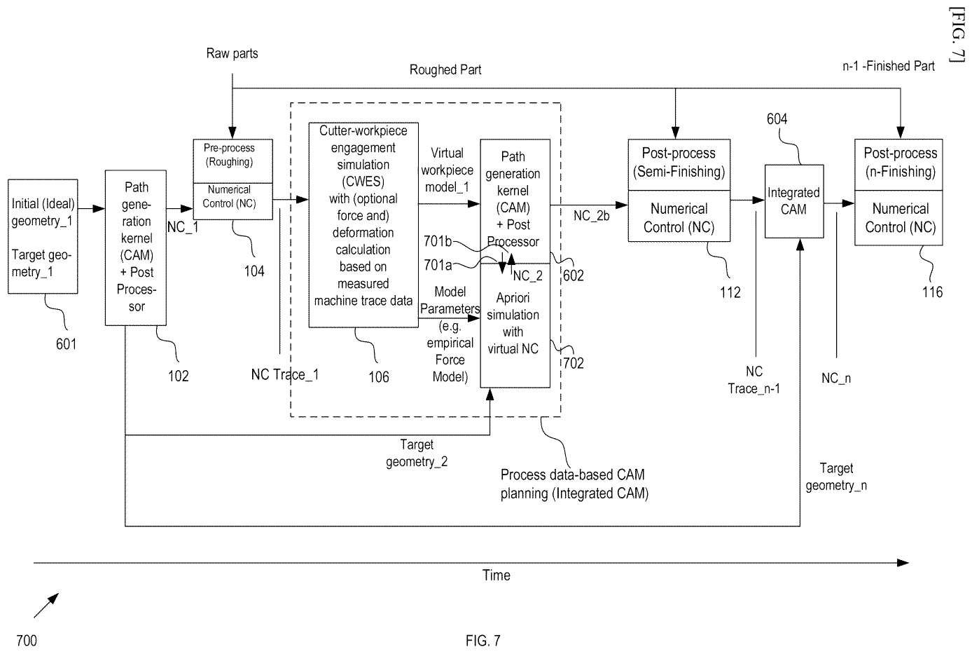

FIG. 7 shows a schematic illustration of steps of a sequence 700 according to some example implementations of the present disclosure.

Sequence 700 generally corresponds to sequence 600 as shown in FIG. 6. However, in sequence 700, an a-priori simulation with a virtual NC 702 is used in the process data-based CAM planning. Using a-priori simulations, uncertainties of properties, and in particular the geometry, of the processed workpiece may be reduced (or even avoided). In some examples, a (freshly) parameterized physical processes simulation (for example capable of measuring a process force and/or a tool deflection) is used.

One or more model parameters (for example an empirical force model) may be provided from the machine-tool (cutter)-workpiece engagement simulation to the a-priori simulation with virtual NC 702.

In this example, the a-priori simulation exchanges data NC_2 with the path generation kernel (CAM) and post processor 602. The arrow downwards (arrow 701a) represents the NC_2 generated above (noting that NC_2 will (slightly) change for each iteration of a-priori simulation/virtual optimization, and may be called NC_2*). The arrow upwards (arrow 701b) is a geometrical offset information after the virtual machining at post process which may be considered in the next path generation above. It may be location/pose dependent and can be relative or absolute. If an offset at the virtual machining is within predefined tolerances, it may send a command to use the NC_2* upwards.

Data NC_2b is then output by the path generation kernel (CAM) and post processor 602 as an input for the numerical control 112 used in the post-process. The integrated CAM may be used n times until the finished workpiece is obtained.

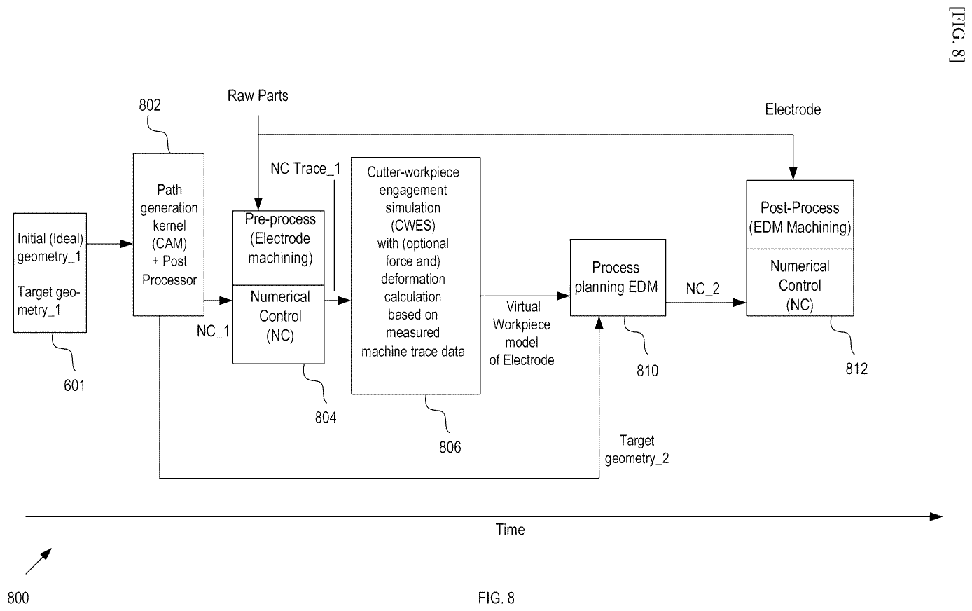

FIG. 8 shows a schematic illustration of steps of a sequence 800 according to some example implementations of the present disclosure. In this example, sequence 800 is applied to machining of an electrical discharge machining (EDM) electrode.

In this example, Initial (Ideal) geometry_1 and Target geometry_1 are input to the path generation kernel (CAM) and post processor. A path generation kernel (CAM) and post processor 802 outputs data/program NC_1 to numerical control 804 used in a pre-process, which is, in this example, an electrode machining process. Raw parts are processed in the pre-process.

Data NC Trace_1 is output by the numerical control 804 and provided to the machining tool (cutter)-workpiece engagement simulation (CWES) with (optional force and) deformation calculation based on measured machine trace data 806. NC Trace_1 may be or comprise a list with several numerical control (NC) and/or programmable logic controller (PLC) and/or sensor data (topics) in the time domain with a synchronized timestamp.

From the machining tool (cutter)-workpiece engagement simulation (CWES), a virtual workpiece model of the electrode is obtained and input (together with the Target geometry_2) in the process planning 810 for the EDM.

Data NC_2 is output from the process planning 810 EDM and input to the numerical control 812 when performing the post-process, which is, in this example, an EDM machining for the electrode.

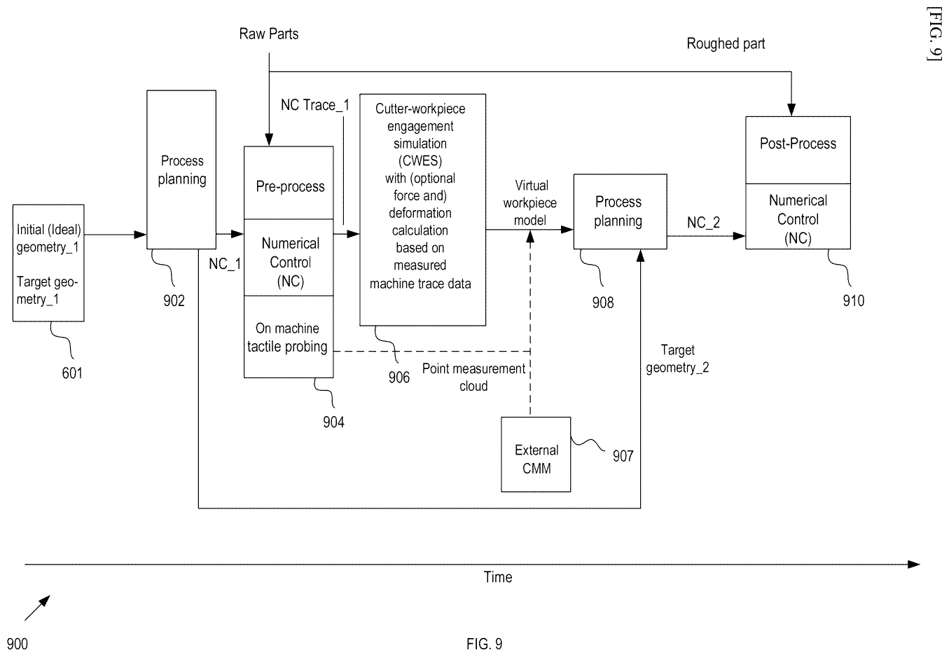

FIG. 9 shows a schematic illustration of steps of a sequence 900 according to some example implementations of the present disclosure. In this example, the virtual workpiece model may be refined by (on machine tactile) probing and/or based on one or more measurements performed with a coordinate measuring machine (CMM).

In this example, Initial (Ideal) geometry_1 and Target geometry_1 are provided for process planning. A process is then planned at step 902 (which may be identical to 802 in sequence 800). Data NC_1 is provided as an input to a numerical control at step 904 which is used for controlling a pre-process. Raw parts are processed in the pre-process.

NC Trace_1 is output by the numerical control and used as an input in the machining tool (cutter)-workpiece engagement simulation (CWES) with (optional force and) deformation calculation based on measured machine trace data at step 906. Based on the machining tool (cutter)-workpiece engagement simulation, a virtual workpiece model is generated and provided (together with Target geometry_2) to a process planning step 908.

Furthermore, in this example, step 904 comprises on machine tactile probing which is used in order to generate a point measurement cloud which is provided together with the virtual workpiece model as an input for the process planning at step 908. Additionally, in this example, an external CCM 907 is provided to generate point measurement cloud data which is input to the process planning 908. As will be appreciated, in some examples, only the machine tactile probing may be used (that is without the external CMM) or only the external CMM may be used (that is without the on machine tactile probing).

From the process planning at step 908, data NC_2 is output and provided to a numerical control 910 for performing a post-process, in this example of the rough parts.

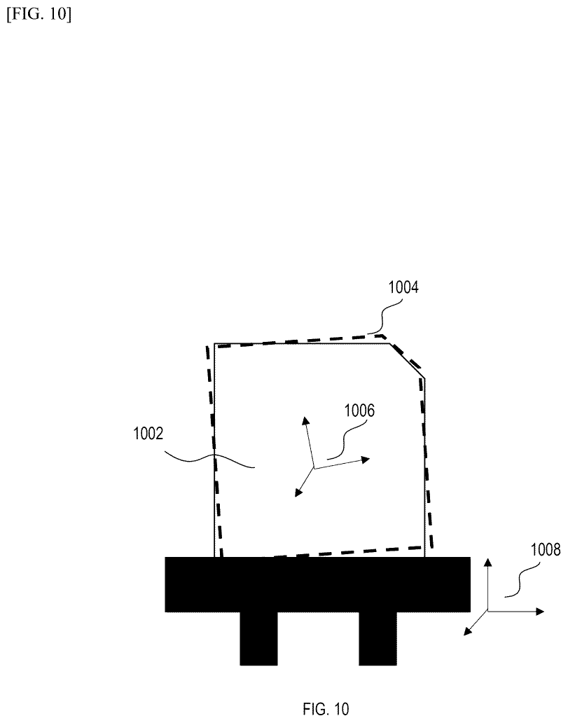

FIG. 10 shows a schematic illustration for refinement of a virtual workpiece model coordinate system according to some example implementations of the present disclosure.

In the schematic illustration, the real workpiece 1002 and the virtual workpiece model 1004 (here illustrated based on the geometrical representation only of the virtual workpiece model) are shown. The zero point 1006 of the virtual workpiece model is illustrated in the center of the virtual workpiece model 1004. Furthermore, the zero point 1008 of the zero-point clamping (ZPC) system is depicted.

In case a fully virtual process chain is used in parallel to the physical process chain, in the real world, progressing errors by misalignment between virtual and real world can be corrected. Loosening effects in the clamping device may be compensated.

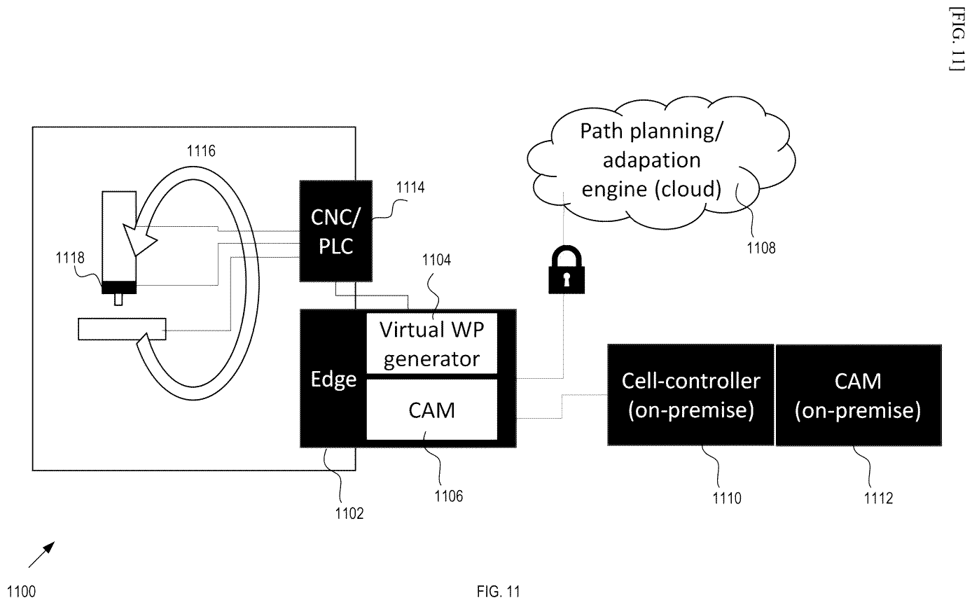

FIG. 11 shows a schematic illustration of a system set-up 1100 according to some example implementations of the present disclosure.

In this example, the system set-up 1100 comprises an Edge PC 1102 comprising a virtual workpiece generator 1104 and a CAM 1106. Different options for the deployment of a path planning or adaptation engine are shown (1106, 1108, 1112).

Edge PC 1102 is an additional computing unit inside the machine tool which allows power intensive calculation without disturbing critical NC operations. It also allows quasi-process parallel calculations. It can host any one or more of the algorithms outlined throughout the present disclosure. The Edge PC 1102 is coupled, in this example, in a secured manner to a cloud in which path planning and/or path adaptation is/are performed by path planning and/or adaptation engine 1108.

Furthermore, in this example, the Edge PC 1102 is coupled to a cell-controller 1110 which is provided on-premise, that is at the site where the machining tool processes the workpiece-job-specific meta-data are provided. Such meta data can be part ID and/or tool data and/or NC data and/or workpiece material data. Additionally, in this example, a CAM 1112 is provided on-premise and is coupled to the Edge PC 1102.

The Edge PC 1102 is further coupled, in this example, to a computerized numerical control (CNC)/programmable logic controller (PLC) 1114. Reference 1116 represents the kinematic from the cutting tool to the workpiece, in which a force loop acts at machining. It is to be noted that the force loop is not part of the maching tool. A spindle integrated force sensor 1118 is provided to measure the force acting at machining.

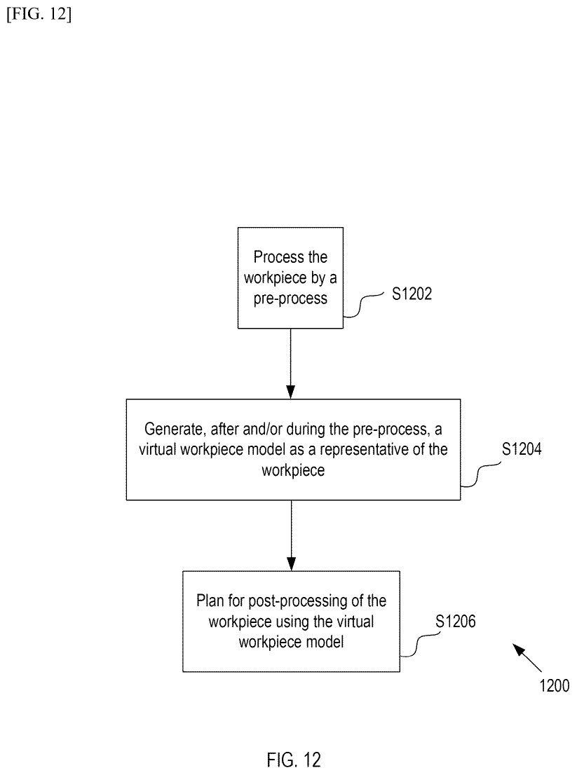

FIG. 12 shows a flow diagram of a method 1200 according to some example implementations of the present disclosure.

In this example, the method 1200 of processing a workpiece comprises, at step S1202, processing the workpiece by a pre-process.

At step S1204, a virtual workpiece model as a representative/representation of the (real) workpiece is generated after and/or during the pre-process.

At step S1206, planning for post-processins of the workpiece is performed using the virtual workpiece model.

The method 1200 of processing a workpiece may be implemented in any one or more of the example implementations outlined throughout the present disclosure, in particular in any one or more of the sequences 100, 200, 300, 400, 600, 700, 800 and 900 outlined above.

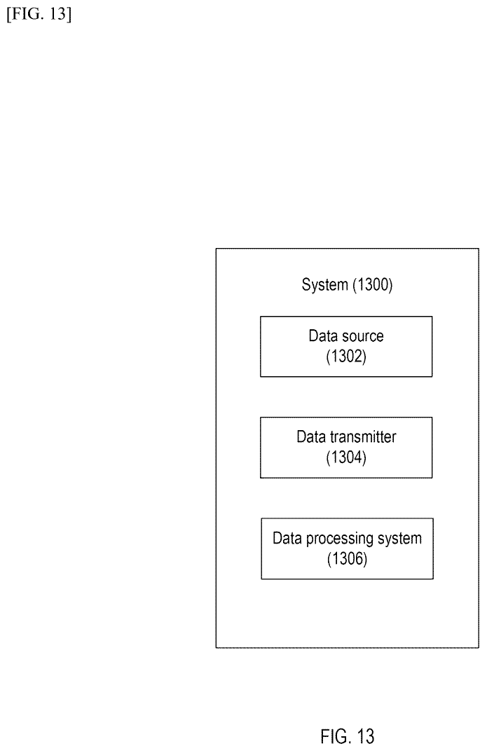

FIG. 13 shows a schematic block diagram of a system 1300 according to some example implementations of the present disclosure.

In this example, the system 1300 comprises a data source 1302, a data transmitter 1304 and a data processing system 1306. The system 1300 is configured to carry out the method according to any one or more of the example implementations outlined throughout the present disclosure, in particular in any one or more of the sequences 100, 200, 300, 400, 600, 700, 800 and 900 outlined above and/or the method 1300 outlined above.

In some examples, the data source 1302 is a machine tool with a data interface for sending and/or reading high-frequently internal machine data. The internal machine data may hereby relate, for example, to the position(s) that the machine tool goes through, currents and/or forces which may act on one or more motors of the machine tool. Generally, the internal machine data may refer to data for controlling the machine tool. In some examples, no data obtained by subsequent measurements may hereby be taken into account for the internal machine data.

The internal machine data may relate to data stemming from the current machining process. In some examples, the internal machine data may relate to one or more of a force, an acceleration, a temperature, a vibration, and other parameters related to the machining process, such as, for example, a bending of the workpiece (for example with a resolution of less than 50 μm) to be produced and/or a mathematical calculation for the drilling/cutting of the machine tool through the workpiece to be produced. The data may be obtained during the (current) machining process. The data may stem from a controller for controlling the machine tool and/or a sensor which may not (at least not directly) be connected the controller.

In some examples, the data source 1302, the data transmitter 1304 and the data processing system 1306 (for the generation of the virtual workpiece model) comprise a software unit for material removal simulation and a software unit for determining deformations, which are provided with a software unit for computer-aided path planning, in particular a machine tool including an edge PC housed therein. Any two or all of the software units mentioned above may be integral to a single software unit.

It is to be noted that path planning, as is used throughout the present disclosure, may not be limited to the understanding of being implemented via computer aided manufacturing only. For example, one or more offset tables on the target location data and/or on actual location data may be included.

Examples as outlined throughout the present disclosure may be applied to die and mold technologies in manufacturing, and/or in finishing of casted, and/or for printed and/or forged products in particular in series production, such as, but not limited to automotive, agriculture, medical, aerospace, semi-conductor and other areas. Examples outlined throughout the present disclosure may include all machining processes, such as, but not limited to milling, turning, grinding, etc. in the pre-machining and/or post-machining step.

The machine internal data as outlined throughout the present disclosure may additionally or alternatively relate to or comprise one or more of deformation of the tool, deformation of the workpiece, static and/or dynamic load on the machine, and compensation of machine and tool geometry related to volumetric and/or thermal effects.

In some example implementations outlined throughout the present disclosure, approaches for the adaptation of a path location at the machine may be taken. All approaches may start after generating the virtual workpiece and a deviation analysis from a target contour. Any variables for the adaptation may be based on a deviation between the virtual workpiece and the target contour. Path adaptation based on edge kernel may allow for adaptations of paths under predefined boundary conditions (in order to reduce the risk for collision or machine damage etc.). No fundamental changes of the number or the orientation of paths may hereby be provided.

The following examples are also encompassed by the present disclosure and may fully or partly be incorporated into embodiments:
1. A method of processing a workpiece, comprising the steps of:
   processing the workpiece by a pre-process;
   generating, after and/or during the pre-process, a virtual workpiece model as a representative of the workpiece; and
   planning for post-processing of the workpiece using the virtual workpiece model.
2. The method according to clause 1, wherein the pre-process and/or post-processing are conducted using one or more NC code blocks.
3. The method according to clause 1 or 2, wherein at least one of the pre-process and post-processing is planned via computer-based path planning.
4. The method according to any one of the preceding clauses, wherein at least one machine tool, a number of which is equal to or less than a number of process steps used to process the workpiece using the pre-process and the post-processing, is used to conduct the pre-process and the post-processing.
5. The method according to clause 4, wherein data from a controller of the machine tool and/or from an integrated sensor in the machine tool are used to generate the virtual workpiece model.
6. The method according to any one of the preceding clauses, wherein the virtual workpiece model is generated quasi-parallel to the pre-process and/or after the pre-process.
7. The method according to clause 6, wherein quasi-parallel means with a latency of less than 50 ms, preferably less than 10 ms.
8. The method according to any one of the preceding clauses, wherein the virtual workpiece model is generated by considering one or more displacements of one or more physical components, wherein the one or more displacements are caused by one or more process forces acting along a force loop.
9. The method according to any one of the preceding clauses, wherein the virtual workpiece model is generated by considering one or more compensation algorithms running on a machine and/or a NC controller.
10. The method according to any one of the preceding clauses, wherein the generation of the virtual workpiece model is conducted with a local geometrical resolution smaller than a part-specific local geometric dimensioning and tolerancing (GDT).
11. The method according to any one of the preceding clauses, wherein, after the pre-process, a micro-/sub-micrometer accurate measurement, in particular conducted by a coordinate measuring machine and/or in-machine tactile probing and/or an optical measurement, and/or a measured point cloud are used to refine and/or correct one or more areas of the virtual workpiece
12. The method according to any one of the preceding clauses, whereby calibration of a process model as a function of one or more boundary conditions is conducted in parallel to the pre-process.
13. The method according to clause 12, whereby the calibrated process model is used for planning the post-processing.
14. The method according to any one of the preceding clauses, whereby calibration of a tool-material-model is conducted parallel to the post-processing.
15. The method according to any one of the preceding clauses, wherein the planning of the post-processing is conducted using an initial workpiece geometry which is based on the virtual workpiece model.
16. The method according to any one of the preceding clauses, wherein the planning of the post-processing is conducted after the pre-process and the generating of the virtual workpiece model.
17. The method according to any one of the preceding clauses, wherein one or more process parameters are adjusted on the basis of higher order shape deviations on the virtual workpiece model at the planning of the post-process.
18. The method according to any one of the preceding clauses, wherein one or more supplementary sensor signals, in particular acceleration data, are added to the virtual workpiece model in a location-related manner.
19. The method according to any one of the preceding clauses, wherein the planning of the post-processing is conducted by using the ideal geometry obtained in the planning of the pre-process as an initial workpiece geometry.
20. The method according to any one of the preceding clauses, further comprising a step of planning one or more paths for the post-processing.
21. The method according to any one of the preceding clauses, wherein one or more initially calculated paths for the post-processing are adjusted based on an additional input generated from the virtual workpiece model.
22. The method according to any one of the preceding clauses, wherein one or more variables for a parametrized NC code and/or a pose-dependent offset table depending on geometry deviation and/or displacement of a tool center point are generated using the virtual workpiece model.
23. The method according to clause 21, or clause 22 when dependent from clause 21, wherein the path adjustment is conducted by a controller of a machine tool so that one or more final paths are generated in an NC device and/or in the machine tool.
24. The method according to clause 21, or clause 22 when dependent from clause 21, or clause 23, wherein one or more target paths for the post-processing are adjusted on-premise and/or in a cloud.
25. The method according to clause 21, or clause 22 when dependent from clause 21, or clause 23 or 24, wherein the path adjustment is less than a predefined threshold, wherein the predefined threshold is based on one or more process parameters for processing the workpiece and/or based on a tool geometry of a tool used to process the workpiece.
26. The method according to clause 25, wherein the threshold is less than half of a tool diameter of the tool.
27. The method according to clause 21, or clause 22 when dependent from clause 21, or any one of clauses 23 to 26, wherein the one or more paths are adjusted by adding a single path segment.
28. The method according to any one of the preceding clauses, wherein the planning of the post-processing includes a determination of a virtual tool-workpiece engagement and calculation of displacement of a tool center point.
29. The method according to clause 28, wherein a tool-material-model which is set-up and/or calibrated in the pre-process is used for the planning.
30. The method according to clause 28 or 29, wherein a virtual NC controller, in particular including one or more offset tables, in particular NC-internal correction/compensation, is used to calculate an expected real path relevant for an a-priori simulation of the virtual workpiece model.
31. The method according to any one of clauses 28 to 30, wherein a target path is generated iteratively in consideration of the displacement of a tool center point.
32. The method according to any one of the preceding clauses, wherein the post-processing is conducted by an electric discharge machine.
33. The method according to any one of the preceding clauses, wherein the post-processing is conducted by an electrochemical machine.
34. The method according to any one of the preceding clauses, further comprising a step of a micro-/sub-micrometer accurate part measurement process after the pre-process, and a corresponding measurement point cloud is used to correct a virtual workpiece coordinate system relative to a reference point, in particular relative to an electrode (EDM) or a cathode (ECM) zero-point clamp.
35. A system configured to carry out the method of any one of the preceding clauses, comprising a data source, a data transmitter and a data processing system.
36. The system according to clause 35, wherein the data source is a machine tool with a data interface for sending and reading machine internal data.
37. The system according to clause 36, wherein the data is provided by the data interface at a frequency of less than 2 kHz for providing a PLC data, and/or between 100 Hz and 20 kHz for providing a servo data, and/or between 2 kHz and 40 kHz for providing a rotor shaft deformation.
38. The system according to clause 36 or 37, wherein the data includes one or more of: electric current supplied to a motor, one or more signals from a rotary and/or linear encoder, a displacement of a tool center point, one or more tool tables, one or more compensation tables, and/or NC blocks.
39. The system according to any one of clauses 35 to 38, wherein the data is obtained from a sensor for measuring a rotor shaft deformation in front of and/or between a pair of bearings.
40. The system according to any one of clauses 35 to 39, wherein the data source is a machine-internal job manager and/or a cell controller and/or a manufacturing execution system.
41. The system according to clause 40, wherein the system is configured to provide job information and/or context information from one or more pre-processes and/or corresponding one or more images of the workpiece.
42. The system according to any one of clauses 35 to 41, wherein the data source, the data transmitter and the data processing system for the generation of the virtual workpiece model, comprises a software unit for material removal simulation and a software unit for the determining deformations, which are provided with a software unit for computer-aided path planning, in particular a machine tool including an edge PCs housed therein.

No doubt many other effective alternatives will occur to the skilled person. It will be understood that the invention is not limited to the described embodiments and encompasses modifications apparent to those skilled in the art and lying within the scope of the claims appended hereto.

1. A method of processing a workpiece, comprising the steps of:
processing the workpiece by a pre-process;
generating, after and/or during the pre-process, a virtual workpiece model as a representative of the workpiece; and
planning for post-processing of the workpiece using the virtual workpiece model.

2. The method according to claim 1, wherein the pre-process and/or post-processing are conducted using one or more NC code blocks.

3. The method according to claim 1, wherein at least one of the pre-process and post-processing is planned via computer-based path planning.

4. The method according to claim 1, wherein at least one machine tool, a number of which is equal to or less than a number of process steps used to process the workpiece using the pre-process and the post-processing, is used to conduct the pre-process and the post-processing.

5. The method according to claim 4, wherein data from a controller of the machine tool and/or from an integrated sensor in the machine tool are used to generate the virtual workpiece model.

6. The method according to claim 1, wherein the virtual workpiece model is generated quasi-parallel to the pre-process and/or after the pre-process.

7. The method according to claim 6, wherein quasi-parallel means with a latency of less than 50 ms, preferably less than 10 ms.

8. The method according to claim 1, wherein the virtual workpiece model is generated by considering one or more displacements of one or more physical components, wherein the one or more displacements are caused by one or more process forces acting along a force loop.

9. The method according to claim 1, wherein the virtual workpiece model is generated by considering one or more compensation algorithms running on a machine and/or a NC controller.

10. The method according to claim 1, wherein the generation of the virtual workpiece model is conducted with a local geometrical resolution smaller than a part-specific local geometric dimensioning and tolerancing (GDT).

11. The method according to claim 1, wherein, after the pre-process, a micro-/sub-micrometer accurate measurement, in particular conducted by a coordinate measuring machine and/or in-machine tactile probing and/or an optical measurement, and/or a measured point cloud are used to refine and/or correct one or more areas of the virtual workpiece model.

12. The method according to claim 1, whereby calibration of a process model as a function of one or more boundary conditions is conducted in parallel to the pre-process.

13. The method according to claim 12, whereby the calibrated process model is used for planning the post-processing.

14. The method according to claim 1, whereby calibration of a tool-material-model is conducted parallel to the post-processing.

15. The method according to claim 1, wherein the planning of the post-processing is conducted using an initial workpiece geometry which is based on the virtual workpiece model.

16. The method according to claim 15, wherein the planning of the post-processing is conducted after the pre-process and the generating of the virtual workpiece model.

17. The method according to claim 1, wherein one or more process parameters are adjusted on the basis of higher order shape deviations on the virtual workpiece model at the planning of the post-process.

18. The method according to claim 1, wherein one or more supplementary sensor signals, in particular acceleration data, are added to the virtual workpiece model in a location-related manner.

19. The method according to claim 1, wherein the planning of the post-processing is conducted by using the ideal geometry obtained in the planning of the pre-process as an initial workpiece geometry.

20. The method according to claim 19, further comprising a step of planning one or more paths for the post-processing.

21. The method according to claim 1, wherein one or more initially calculated paths for the post-processing are adjusted based on an additional input generated from the virtual workpiece model.

22. The method according to claim 21, wherein one or more variables for a parametrized NC code and/or a pose-dependent offset table depending on geometry deviation and/or displacement of a tool center point are generated using the virtual workpiece model.

23. The method according to claim 21, wherein the path adjustment is conducted by a controller of a machine tool so that one or more final paths are generated in an NC device and/or in the machine tool.

24. The method according to claim 21, wherein one or more target paths for the post-processing are adjusted on-premise and/or in a cloud.

25. The method according to claim 21, wherein the path adjustment is less than a predefined threshold, wherein the predefined threshold is based on one or more process parameters for processing the workpiece and/or based on a tool geometry of a tool used to process the workpiece.

26. The method according to claim 25, wherein the threshold is less than half of a tool diameter of the tool.

27. The method according to claim 21, wherein the one or more paths are adjusted by adding a single path segment.

28. The method according to claim 1, wherein the planning of the post-processing includes a determination of a virtual tool-workpiece engagement and calculation of displacement of a tool center point.

29. The method according to claim 28, wherein a tool-material-model which is set-up and/or calibrated in the pre-process is used for the planning.

30. The method according to claim 28, wherein a virtual NC controller, in particular including one or more offset tables, in particular NC-internal correction/compensation, is used to calculate an expected real path relevant for an a-priori simulation of the virtual workpiece model.

31. The method according to claim 28, wherein a target path is generated iteratively in consideration of the displacement of a tool center point.

32. The method according to claim 1, wherein the post-processing is conducted by an electric discharge machine.

33. The method according to claim 1, wherein the post-processing is conducted by an electrochemical machine.

34. The method according to claim 1, further comprising a step of a micro-/sub-micrometer accurate part measurement process after the pre-process, and a corresponding measurement point cloud is used to correct a virtual workpiece coordinate system relative to a reference point, in particular relative to an electrode (EDM) or a cathode (ECM) zero-point clamp.

35. A system configured to carry out the method of claim 1, comprising a data source, a data transmitter and a data processing system.

36. The system according to claim 35, wherein the data source is a machine tool with a data interface for sending and reading machine internal data.

37. The system according to claim 36, wherein the data is provided by the data interface at a frequency of less than 2 kHz for providing a PLC data, and/or between 100 Hz and 20 kHz for providing a servo data, and/or between 2 kHz and 40 kHz for providing a rotor shaft deformation.

38. The system according to claim 36, wherein the data includes one or more of: electric current supplied to a motor, one or more signals from a rotary and/or linear encoder, a displacement of a tool center point, one or more tool tables, one or more compensation tables, and/or NC blocks.

39. The system according to claim 35, wherein the data is obtained from a sensor for measuring a rotor shaft deformation in front of and/or between a pair of bearings.

40. The system according to claim 35, wherein the data source is a machine-internal job manager and/or a cell controller and/or a manufacturing execution system.

41. The system according to claim 40, wherein the system is configured to provide job information and/or context information from one or more pre-processes and/or corresponding one or more images of the workpiece.

42. The system according to claim 35, wherein the data source, the data transmitter and the data processing system for the generation of the virtual workpiece model, comprises a software unit for material removal simulation and a software unit for the determining deformations, which are provided with a software unit for computer-aided path planning, in particular a machine tool including an edge PCs housed therein.
